(19) United States
(12) Patent Application Publication
(10) Pub. No.: US 2022/0170677 A1
(43) Pub. Date: Jun. 2, 2022

(54) APPARATUS FOR CONNECTION TO AN HVAC-R SYSTEM DURING MAINTENANCE OR COMMISSIONING AND METHODS OF MAINTENANCE OR COMMISSIONING FOR AN HVAC-R SYSTEM

(71) Applicant: ASPEN PUMPS LIMITED, Hailsham East Sussex (GB)

(72) Inventor: Chris Forshaw, Hailsham East Sussex (GB)

(73) Assignee: ASPEN PUMPS LIMITED, Hailsham East Sussex (GB)

(21) Appl. No.: 17/614,803

(22) PCT Filed: May 20, 2020
(86) PCT No.: PCT/GB2020/051226

§ 371 Date: Nov. 29, 2021

(30) Foreign Application Priority Data
May 30, 2019 (GB) 1907684.3

(51) Int. Cl. F25B 41/40; F04D 15/00; F16K 11/00; F24D 19/10; F28D 1/053

(52) U.S. Cl. CPC F25B 41/40; F04D 15/0005; F16K 11/00; F24D 19/1033; F25B 2700/19; F25B 2345/002; F25B 2345/003; F25B 2345/006; F25B 2600/2519; F28D 1/05383

(57) ABSTRACT

The present application provides apparatus (15) for connection to an HVAC-R system during maintenance or commissioning. The apparatus includes a plurality of ports (16, 17, 18) for fluid connection to the HVAC-R system and to maintenance apparatus, for example a refrigerant tank, a refrigerant recovery unit and/or a vacuum pump. The apparatus also includes a plurality of fluid connections (20) between the plurality of ports, each of the plurality of fluid connections having an electrically actuatable valve (21) to open and close the fluid connection. The apparatus also includes a control unit configured to control each of the electrically actuatable valves to configure the plurality of fluid connections.

The present disclosure relates to maintenance or commissioning of HVAC-R systems, in particular apparatus for connection to an HVAC-R system during maintenance or commissioning, and to methods of maintenance or commissioning for an HVAC-R system.

### BACKGROUND

Heating, ventilation, air conditioning and refrigeration (HVAC-R) systems typically use a refrigerant fluid to transfer heat from one area to another in order to cool and/or heat specific areas.

During maintenance of an HVAC-R system a technician will use various tools that connect to the HVAC-R system to perform a maintenance procedure. For example, such a procedure might be recovering refrigerant from the HVAC-R system, vacuum testing the HVAC-R system, or charging the HVAC-R system with refrigerant. These tools include a recovery unit that has a pump for removing refrigerant from the HVAC-R system, a refrigerant tank for storing refrigerant, and a vacuum pump. Other examples of tools used in HVAC-R maintenance or commissioning procedures include vacuum gauges, temperature sensors, and pressure gauges.

It is known to provide analog or digital vacuum gauges, pressure gauges and temperature sensors. It is also known for digital gauges to include Bluetooth connectivity for communication with an application on a mobile device.

### BRIEF SUMMARY OF THE DISCLOSURE

In accordance with the present disclosure there is provided apparatus for connection to an HVAC-R system during maintenance or commissioning, the apparatus comprising:

a plurality of ports for fluid connection to the HVAC-R system and to maintenance apparatus, for example a refrigerant tank, a refrigerant recovery unit and/or a vacuum pump, a plurality of fluid connections between the plurality of ports, each of the plurality of fluid connections having an electrically actuatable valve to open and close the fluid connection, a control unit configured to control each of the electrically actuatable valves to configure the plurality of fluid connections.

The control unit may further comprise a communications unit configured to communicate with a remote device. The communications unit may comprise a Bluetooth communications unit. In other examples, the communications unit may be configured to communicate with a remote device over a mobile communications network. In preferred examples, the communications unit includes a receiver for receiving data, for example instructions, from the remote device. The communications unit may comprise a transceiver for receiving data, for example instructions, from the remote device, and for transmitting data to the remote device. In some examples, the communications unit may further comprise an additional transmitter and/or receiver, for example a Bluetooth transmitter and/or receiver. In examples, the remote device may be a mobile phone or a tablet computer, or any device that can connect to a mobile communications network.

In preferred examples, the communications unit comprises a transceiver configured to communicate on a mobile communications network, for example a GSM, LTE, UMTS, WiMax, LTE-A, and/or 5G mobile communications network, a Low Power Wide Area Network (LPWAN) radio technology, for example a Narrowband IoT network. The communications unit may be configured to communicate with a remote device via the communications unit using the mobile communications network. The communications unit communicates data to the remote device, for example using SMS format.

Advantageously, communicating with the remote device over a mobile communications network removes the need for the remote device to be proximate to the apparatus. For example, Bluetooth connectivity is limited in range, whereas using a mobile communications network allows the operator to be further removed from the apparatus, which may be advantageous during long maintenance procedures or when the operator needs to investigate parts of the HVAC-R system that are removed from the position of the apparatus.

In examples, the plurality of ports may comprise a first port for connection to a high pressure service port of the HVAC-R system and a second port for connection to a low pressure service port of the HVAC-R system. In further examples, the plurality of ports further comprises a maintenance port for connection to the maintenance apparatus.

In examples, the plurality of ports may comprise a first maintenance port and a second maintenance port, and wherein the plurality of ports optionally further comprises a third maintenance port. In examples, the apparatus may comprise a fluid connection between the first maintenance port and the second maintenance port, and the fluid connection may comprise an electrically actuatable valve to open and close the fluid connection.

Preferably, the or each maintenance port is connectable to both of the first port and the second port via fluid connections, and each of the fluid connections may comprise an electrically actuatable valve to open and close the fluid connection.

In examples, the apparatus further comprises a pressure sensor arranged to detect a pressure of fluid in at least one fluid connection.

In examples, the apparatus further comprises a temperature sensor arranged to detect a temperature of fluid in at least one fluid connection.

Preferably, at least one of, and preferably all of, the electrically actuatable valves are biased to a closed position.

The control unit may be configured to receive an input for configuring the electrically actuatable valves. Additionally or alternatively, the control unit may comprise a memory configured to store pre-set configurations of the electrically actuatable valves, and the control unit may be configured to retrieve a pre-set configuration from the memory.

In some examples, the control unit comprises an input device, and the control unit may be configured to configure the electrically actuatable valves in accordance with a user instruction provided to the control unit via the input device.

In some examples, the apparatus further comprises a pump for pumping refrigerant fluid. Additionally or alternatively, the apparatus may further comprise a vacuum pump. Additionally or alternatively, the apparatus may comprise a housing to which the ports, fluid connections and electrically actuatable valves are attached. Preferably, the housing is portable.

In accordance with the present disclosure, there is also provided a method of performing maintenance or commissioning on an HVAC-R system, the method comprising:
providing the apparatus of any preceding claim,
connecting a first port of the apparatus to the HVAC-R system;
connecting a second port of the apparatus to maintenance apparatus; and
configuring the electrically actuatable valves to provide a fluid connection between the first port and the second port.

In accordance with the present disclosure, there is also provided a method of performing maintenance or commissioning on an HVAC-R system, the method comprising:
providing the apparatus described above, the apparatus comprising:
a first port for connection to a high pressure service port of the HVAC-R system;
a second port for connection to a low pressure service port of the HVAC-R system; and
at least one maintenance port for connection to the maintenance apparatus;
and wherein the method further comprises:
connecting at least one of the first port and the second port of the apparatus to the HVAC-R system,
connecting the maintenance port of the apparatus to maintenance or commissioning apparatus, and
configuring the electrically actuatable valves to provide a fluid connection between the first port and/or the second port and the maintenance port.

In some examples, for example for performing a refrigerant recovery operation, the method may comprise:
connecting the first port of the apparatus to a high pressure service port of the HVAC-R system;
connecting first and second maintenance ports of the apparatus to an intake and an outlet of a recovery unit, respectively;
connecting a third maintenance port to a refrigerant tank; and
configuring the electrically actuatable valves to provide fluid connections between the first port and the first maintenance port, and between the second maintenance port and the third maintenance port.

In some examples, for example for performing a refrigerant recovery operation, the method may comprise:
connecting the second port of the apparatus to a low pressure service port of the HVAC-R system;
connecting first and second maintenance ports of the apparatus to an intake and an outlet of a recovery unit, respectively;
connecting a third maintenance port to a refrigerant tank; and
configuring the electrically actuatable valves to provide fluid connections between the second port and the first maintenance port, and between the second maintenance port and the third maintenance port.

In some examples, for example for performing a vacuum test, the method may comprise:
connecting the first port of the apparatus to a high pressure service port of the HVAC-R system;
connecting a first maintenance port of the apparatus to an intake of a vacuum pump; and,
configuring the electrically actuatable valves to provide a fluid connection between the first port and the first maintenance port.
In some examples, for example for performing a vacuum test, the method may comprise:
connecting the second port of the apparatus to a low pressure service port of the HVAC-R system;
connecting a first maintenance port of the apparatus to an intake of a vacuum pump; and,
configuring the electrically actuatable valves to provide a fluid connection between the second port and the first maintenance port.

In one example, for example for charging the HVAC-R system with refrigerant, the method may further comprise:
connecting the first port of the apparatus to a high pressure service port of the HVAC-R system, and/or connecting the second port of the apparatus to a low pressure service port of the HVAC-R system;
connecting a third maintenance port to a refrigerant tank; and
configuring the electrically actuatable valves to provide a fluid connection between the third maintenance port and at least one of the first port and the second port.

It will be understood that any data processing, can be performed by a device having one or more processors and a memory including instructions to cause the one or more processors to perform the data processing, such as to process the scan data to generate the control data. The memory is typically a non-transient computer-readable storage medium.

### BRIEF DESCRIPTION OF THE DRAWINGS

Embodiments of the invention are further described hereinafter with reference to the accompanying drawings, in which:

FIG. 1 is a system diagram of a typical HVAC-R system;

FIG. 2 is a schematic diagram of apparatus for connection to the HVAC-R system of FIG. 1, in particular a hub for connection to the HVAC-R system of FIG. 1;

FIGS. 3A to 3C are schematic diagrams of the hub of FIG. 2 when attached to the HVAC-R system of FIG. 1 to recover refrigerant from the HAVC-R system;

FIGS. 4A and 4B are schematic diagrams of the hub of FIG. 2 when attached to the HVAC-R system of FIG. 1 to performing a vacuum test on the HAVC-R system;

FIG. 5 is a schematic diagram of the hub of FIG. 2 when attached to the HVAC-R system of FIG. 1 to charge the HAVC-R system with refrigerant; and

FIG. 6 is a system diagram for apparatus for connection to an HVAC-R system during maintenance or commissioning.

### DETAILED DESCRIPTION

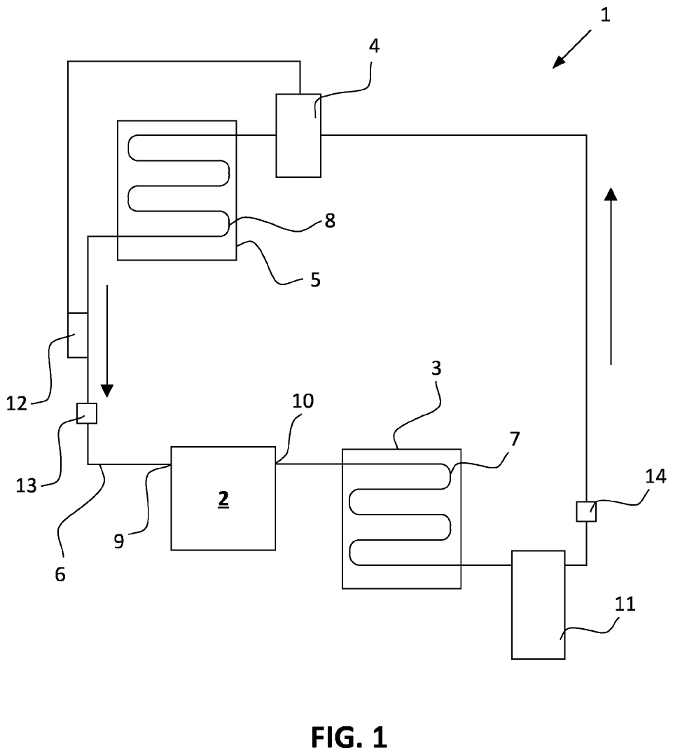

As shown in FIG. 1, an HVAC-R system 1 includes a compressor 2, a condenser 3, an expansion valve 4, and an evaporator 5. Pipes 6 connect each of these components in a loop such that refrigerant fluid can flow through each in turn, driven by the compressor 2. The condenser 3 typically includes a coil of pipes 7 wound to create a large surface area for heat exchange between the refrigerant fluid and air surrounding the condenser 3. The evaporator 5 is similar, having a coil of pipes 8 that create a large surface area for heat exchange between the refrigerant fluid and the air surrounding the evaporator 5. In a refrigerant or air conditioning system, the evaporator 5 is typically disposed within the conditioned area, e.g. within a house or refrigerated room, and the condenser 3 is typically disposed outside of the conditioned area, e.g. outside of the house or refrigerated room.

The compressor 2 may be any compressor of an HVAC-R system, for example one of a reciprocating compressor, a rotary compressor, a scroll compressor, a screw compressor or a centrifugal compressor. The compressor 2 has an intake 9 and an outlet 10, and drives refrigerant through the HVAC-R system 1 as described hereinafter.

During operation, the compressor intake 9 receives refrigerant fluid as a low pressure gas, and compresses the low pressure gas into a high pressure gas. Compressing the gas to increase the pressure will also increase the temperature of the refrigerant. Therefore, at the compressor outlet 10 the refrigerant fluid is a high pressure, high temperature gas.

After outlet from the compressor 2, the high pressure, high temperature gas enters the condenser 3, which is a heat exchanger located in an area with a lower temperature than the refrigerant entering the condenser 3. In air conditioning or refrigeration examples, the condenser 3 is located externally of the conditioned area, for example outside of a building or outside of a refrigerated area. As the refrigerant flows through the condenser 3, heat is lost from the high pressure, high temperature gas within the condenser 3 to a surrounding area, and the refrigerant fluid exits the condenser 3 as a high pressure liquid having a lower temperature than upstream of the condenser 3. At this stage, the refrigerant fluid is warm, but not as hot as upstream of the condenser 3 because some heat has been lost in the condenser 3, and the refrigerant fluid has condensed into a liquid.

Optionally, a receiver drier 11 is positioned downstream of the condenser 3. The high pressure liquid passes through the receiver drier 11. The receiver drier 11 contains extra refrigerant fluid for the HVAC-R system 1, to account for changes due to small leaks or temperature fluctuations. The receiver drier 11 may also include a drying agent and a filter to remove contaminants from the refrigerant fluid.

The high pressure liquid next passes through the expansion valve 4. The expansion valve 4 typically includes a metered orifice through which the refrigerant fluid must pass. The metered orifice limits the rate at which the refrigerant fluid flows. As a result of this, a large pressure drop is created across the metered orifice. Therefore, as the refrigerant fluid passes through the metered orifice the high pressure liquid quickly loses pressure. The loss of pressure also cools the refrigerant fluid. Therefore, after the expansion valve 4 the refrigerant fluid is at a cold temperature and at a lower pressure, and is starting to evaporate into a gas.

Immediately after the expansion valve 4 the cold refrigerant fluid enters the evaporator 5. In air conditioning or refrigeration examples, the evaporator 5 is typically disposed in an area to be cooled or refrigerated, for example inside a building or a refrigeration unit. Within the evaporator 5 the low temperature refrigerant fluid is heated by absorbing heat from the surroundings of the evaporator 5. On exit from the evaporator 5 the refrigerant fluid has been evaporated and is a low pressure gas, which is still cool but at a higher temperature than immediately upstream of the evaporator 5 because it has absorbed heat from the surroundings of the evaporator 5.

This low pressure gas is fed back to the compressor intake 9. In this way, the refrigerant fluid transfers heat from the evaporator 5 to the condenser 3, and therefore from one area to another, to cool the area where the evaporator 5 is located and/or to heat the area where the condenser 3 is located.

It will be appreciated that the boiling point of the refrigerant fluid is not the same as water or air. For example, the boiling point of Ammonia (R717), a typical refrigerant, is −33.3 degrees Celsius. Therefore, it will be appreciated that the high and low temperatures referred to in the description are relative, and the refrigerant fluid can be used in the described manner to efficiently transfer heat from the evaporator 5 to the condenser 3.

As shown in FIG. 1, in examples in which the HVAC-R system 1 is used to cool the area surrounding the evaporator 5, the HVAC-R system 1 may further include a thermal expansion valve 12 for controlling the metered orifice of the expansion valve 4. The thermal expansion valve 12 is arranged to expand and contract according to the temperature of the refrigerant fluid downstream of the evaporator 5. In this way, the thermal expansion valve 12 expands or contracts according to the temperature of the surroundings of the evaporator 5, which directly determines the temperature of the refrigerant downstream of the evaporator 5. The expanded/contracted state of the thermal expansion valve 12 controls the size of the metered orifice in the expansion valve 4, so that the flow of refrigerant (and the cooling provided to the surroundings of the evaporator 5) is proportionate to the temperature of the surroundings of the evaporator 5. A smaller metered orifice in the expansion valve 4 will create a lower temperature refrigerant and provide more cooling to the area surrounding the evaporator 5. In this example, a warmer refrigerant downstream of the evaporator 5, indicated by relatively high thermal expansion of the thermal expansion valve 12, indicates that more cooling is required. Therefore, the thermal expansion valve 12 is configured to reduce the size of the metered orifice in response to thermal expansion, and is configured to increase the size of the metered orifice in response to thermal contraction.

To improve heat exchange at the evaporator 5 and/or at the condenser 3, a fan may be provided to create a flow of air over the coiled pipes 7, 8 of the evaporator 5 and/or the condenser 3.

As explained above, the pressure of the refrigerant fluid is higher between the compressor outlet 10 and the expansion valve 4, and lower between the expansion valve 4 and the compressor intake 9. Therefore, the HVAC-R system has a high pressure side and a low pressure side.

Also shown in FIG. 1, a low pressure service port 13 is provided between the evaporator 5 and the compressor intake 9, where the refrigerant fluid is at low pressure. Similarly, a high pressure service port 14 is provided between the condenser 3 (or drier 11) and the expansion valve 4, where the refrigerant fluid is at high pressure. The low pressure and high pressure service ports 13, 14 are provided for removing and adding refrigerant to the HVAC-R system 1 during maintenance or commissioning, as explained further hereinafter.

It will be appreciated that various HVAC-R systems may include additional or alternative components or arrangements for different applications. The apparatus described hereinafter, for maintenance or commissioning of HVAC-R systems, can be used on any HVAC-R system that includes a high pressure side and a low pressure side, and includes at least one service port (high pressure side and/or low pressure side) for removal or addition of refrigerant fluid to the HVAC-R system. As described above, a typical HVAC-R system 1 will include a high pressure service port 14 and a low pressure service port 13.

During maintenance and commissioning of an HVAC-R system 1 various procedures are carried out, and the main procedures are described briefly hereinafter. The procedures are typically carried about by trained technicians, who make use of various tools, as also described further hereinafter.

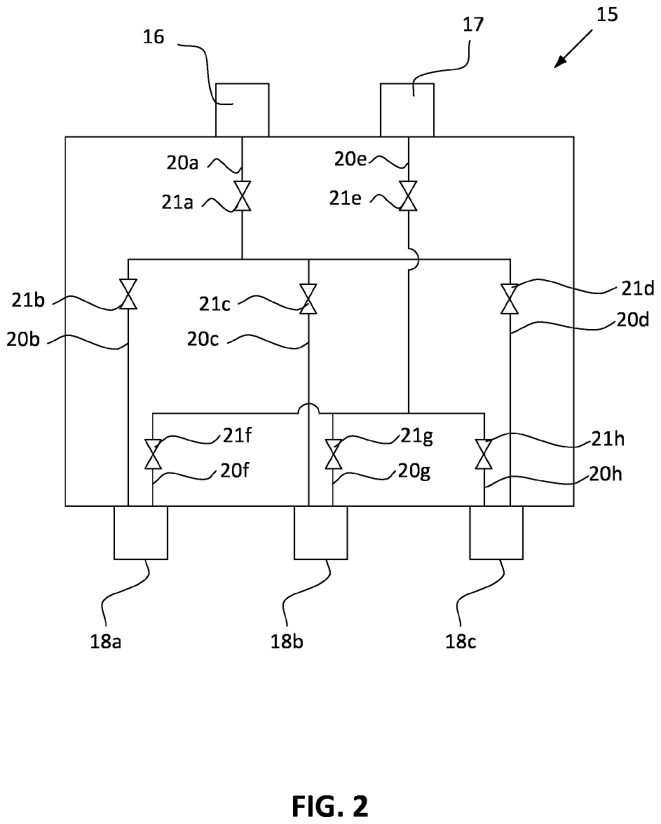

FIG. 2 illustrates apparatus that forms a part of the present invention, in particular a hub 15. As explained further hereinafter, during maintenance and commissioning the hub 15 is fluidly connected to the HVAC-R system 1 described with reference to FIG. 1, in particular one or both of the high pressure service port 14 and the low pressure service port 13. In addition, maintenance apparatus is connected to the hub 15, for example a vacuum pump, a recovery unit and/or a refrigerant tank. The hub 15 has a number of ports for connection to the HVAC-R system 1 and for connecting the maintenance apparatus. The hub 15 also includes a series of fluid connections between the different ports, and a series of electrically actuatable valves that can be controlled to configure the fluid connections between the different ports. In this way, fluid connections between the HVAC-R system 1 and the maintenance tools can be configured within the hub 15 for different maintenance and commissioning procedures.

In preferred embodiments, the hub 15 comprises a housing in which the ports, fluid connections and electrically actuatable valves are housed. The hub is thereby portable for moving to the site of the HVAC-R system 1 for maintenance or commissioning. The hub 15 is therefore a tool for an HVAC-R technician.

The hub 15 also comprises a control unit that controls the electrically actuatable valves in order to configure the fluid connections between the different ports in the hub. The control unit also has a communications unit for communicating with a remote device, for example an application on a tablet computer or mobile phone. This advantageously allows the technician to control all fluid connections between their tools and the HVAC-R system 1 via the communications unit and the hub 15.

Additionally, the communications unit of the hub 15 may communicate with tools that have no fluid connection to the hub 15 and/or to the HVAC-R system 1 but do include a data connection. For example, the communications unit may communicate with scales or temperature sensors having Bluetooth connectivity.

In preferred examples, the communications unit of the hub 15 is configured to communicate with a remote device over a mobile communications network. The control unit is in data communication with the communications unit. In preferred examples, the communications unit includes a receiver for receiving data, for example instructions, from the remote device. The communications unit may comprise a transceiver for receiving data, for example instructions, from the remote device, and for transmitting data to the remote device. In some examples, the communications unit may further comprise an additional transmitter and/or receiver, for example a Bluetooth transmitter and/or receiver. In examples, the remote device may be a mobile phone or a tablet computer, or any device that can connect to a mobile communications network.

In preferred examples, the communications unit comprises a transceiver configured to communicate on a mobile communications network, for example a GSM, LTE, UMTS, WiMax, LTE-A, and/or 5G mobile communications network, a Low Power Wide Area Network (LPWAN) radio technology, for example a Narrowband IoT network. The communications unit may be configured to communicate with a remote device via the communications unit using the mobile communications network. The communications unit communicates data to the remote device, for example using SMS format.

In some examples, as explained further hereinafter, the control unit may be configured to control the fluid connections within the hub 15 to perform a maintenance or commissioning procedure, for example refrigerant fluid recovery, a vacuum test, and/or charging refrigerant fluid. Furthermore, the control unit may be configured to control the maintenance tools to perform a maintenance or commissioning procedure. In some examples, the control unit may be configured to control the fluid connections within the hub and the maintenance tools to perform a maintenance or commissioning procedure.

As shown in FIG. 2, the hub 15 comprises a first port 16 and a second port 17 for connection to the HVAC-R system 1 describe with reference to FIG. 1. In particular, the first port 16 can be connected to the high pressure service port 14 of the HVAC-R system 1 and the second port 17 can be connected to the low pressure service port 13 of the HVAC-R system 1. The first and second ports 16, 17 can be connected to the high pressure and low pressure service ports 14, 13 using refrigerant hoses. The first and second ports 16, 17 may have connectors, for example threaded connectors, for attachment of the refrigerant hoses. The connectors, for example threaded connectors, of the first and second ports 16, 17 may be different. For example, they may be different sizes, so that refrigerant hoses from the high pressure and low pressure service ports 14, 13 can only be connected to the first and second ports 16, 17 in one configuration. In preferred examples, the threaded connectors of the first and second ports 16, 17 are configured for attachment to standard refrigerant hoses as used in HVAC-R maintenance. For example, the threaded connectors of the first and second ports 16, 17 may have a threaded connection with size: ⅛ inch (3.175 mm), or ⅜ inch (9.525 mm), or % inch (12.7 mm), or ⅞ inch (22.225 mm). In preferred examples, the threaded connectors are′ inch (6.35 mm) SAE connectors. Preferably, the first and second ports 16, 17 comprise a male threaded connector.

The hub 15 also comprises at least one maintenance port 18. In the example of FIG. 2, the hub 15 has three maintenance ports 18a, 18b, 18c. The maintenance ports 18 can be connected to maintenance apparatus using refrigerant hoses. The maintenance ports 18 may have connectors, for example threaded connectors, for attachment of the refrigerant hoses. The maintenance ports 18 may have the same connectors as each other, or they may have different connectors, for example for attachment of specific maintenance or commissioning tools. In preferred examples, the threaded connectors of the at least one maintenance port 18 are configured for attachment to standard refrigerant hoses as used in HVAC-R maintenance. For example, the threaded connectors of the at least one maintenance port 18 may have a threaded connection with size: ⅛ inch (3.175 mm), or ⅜ inch (9.525 mm), or % inch (12.7 mm), or ⅞ inch (22.225 mm). In preferred examples, the threaded connectors are′ inch (6.35 mm) SAE connectors. Preferably, the at least one maintenance port 18 comprise a male threaded connector.

In some examples, the first port 16 and the second port 17 include a manual valve for manual closing of the first port 16 and the second port 17. In some examples, each of the maintenance ports 18 include a manual valve for manual closing of the maintenance ports 18.

A fluid connection is provided between each of the first and second ports 16, 17 and each of the maintenance ports 18. In preferred examples, the fluid connections are formed by pipes 20. In other examples, the fluid connections may be formed by hoses. In the example illustrated in FIG. 2, the hub 15 comprises first and second ports 16, 17, and first, second and third maintenance ports 18a, 18b, 18c, as well as:
a first port branch pipe 20a, connected to the first port 16 and to
first, second and third maintenance port pipes 20b, 20c, 20d that are connected to the first, second and third maintenance ports 18a, 18b, 18c, respectively; and
a second port branch pipe 20e, connected to the second port 17 and to
fourth, fifth and sixth maintenance port pipes 20f, 20g, 20h that are connected to the first, second and third maintenance ports 18a, 18b, 18c, respectively.

The first port branch pipe 20a has an electrically actuatable valve 21a, and each of the first to third maintenance port pipes 20b, 20c, 20d has an electrically actuatable valve 21b, 21c, 21d. The second port branch pipe 20e has an electrically actuatable valve 21e, and each of the fourth to sixth maintenance port pipes 20f, 20g, 20h has an electrically actuatable valve 21f, 21g, 21h.

As described above, the hub includes a control unit configured to control each of the electrically actuatable valves 21a-21h.

The arrangement of pipes 20a-20h and valves 21a-21h in the hub 15 allows the control unit to open or close a fluid connection between different ports 16, 17, 18 of the hub 15, including between the first port 16 and any one or more of the maintenance ports 18a-18c, between the second port 17 and any one or more of the maintenance ports 18a-18c, or between any two of the maintenance ports 18a-18c.

In preferred examples, the electrically actuatable valves 21a-21h are solenoid valves. Preferably, the electrically actuatable valves 21a-21h comprise a biasing member, for example a spring, arranged to bias the valves into a closed position in the absence of power and/or a control signal. In this way, the default position of each electrically actuatable valve 21a-21h is closed, thus safeguarding against accidental leak or mixing of gas and liquid refrigerant if an electrically actuatable valve 21a-21h were open at a wrong time.

In some examples, the hub 15 further comprises one or more pressure sensors arranged to detect the pressure of fluid in a pipe 20a-20h. For example, a pressure sensor may be arranged on each of the first port branch pipe 20a and the second port branch pipe 20e to detect the refrigerant fluid pressure at the first and second ports 16, 17.

Additionally or alternatively, a pressure detector may be arranged on each of the first to sixth maintenance port pipes 20b, 20c, 20d, 20f, 20g, 20h to detect refrigerant fluid pressure in each of the maintenance port pipes 20b, 20c, 20d, 20f, 20g, 20h.

The one or more pressure detectors are preferably digital pressure sensors, and preferably comprise a communication unit to communicate with the control unit and/or with a remote device. Additionally or alternatively, the one or more pressure detectors may comprise an analog pressure gauge for displaying the detected pressure.

In some examples, the hub 15 further comprises one or more temperature sensors arranged to detect the temperature of refrigerant fluid in a pipe 20a-20h. For example, a temperature sensor may be arranged on each of the first port branch pipe 20a and the second port branch pipe 20e to detect the refrigerant fluid temperature at the first and second ports 16, 17.

Additionally or alternatively, a temperature detector may be arranged on each of the first to sixth maintenance port pipes 20b, 20c, 20d, 20f, 20g, 20h to detect refrigerant fluid temperature in each of the maintenance port pipes 20b, 20c, 20d, 20f, 20g, 20h.

The one or more temperature detectors are preferably digital temperature sensors, and preferably comprise a communication unit to communicate with the control unit and/or with a remote device. Additionally or alternatively, the one or more temperature detectors may comprise a display for displaying the detected temperature.

The hub 15 preferably comprises a power supply, for example a mains power connection, for powering the control unit and/or the electrically actuatable valves 21a-21h and/or other electronic components of the hub 15. In other examples, the hub 15 may comprise a battery power source, preferably a rechargeable battery power source.

In some examples, the hub 15 may comprise one or more maintenance ports for each specific maintenance tool. For example, the hub may comprise first and second maintenance ports for a recovery unit, a third maintenance port for a vacuum pump, and a fourth maintenance port for a refrigerant tank. These maintenance ports may comprise connectors that only permit connection to the correct maintenance tool.

In other examples, the hub 15 may comprise a plurality of maintenance ports that are each adapted for connection to various maintenance tools. For example, as described further hereinafter, each of the maintenance ports 18 may comprise the same connector that can be connected to any of the maintenance tools.

In other examples, the hub 15 may comprise at least one specific maintenance port, having a connector for a specific maintenance tool, and at least one generic maintenance port, having a connector adapted for connection to various maintenance tools.

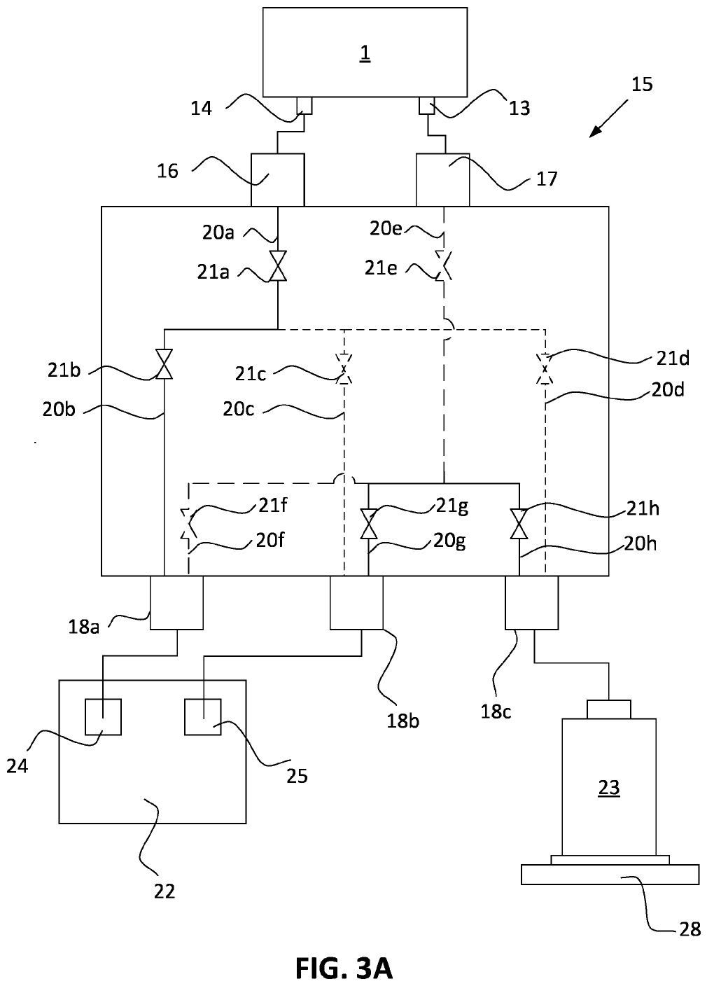

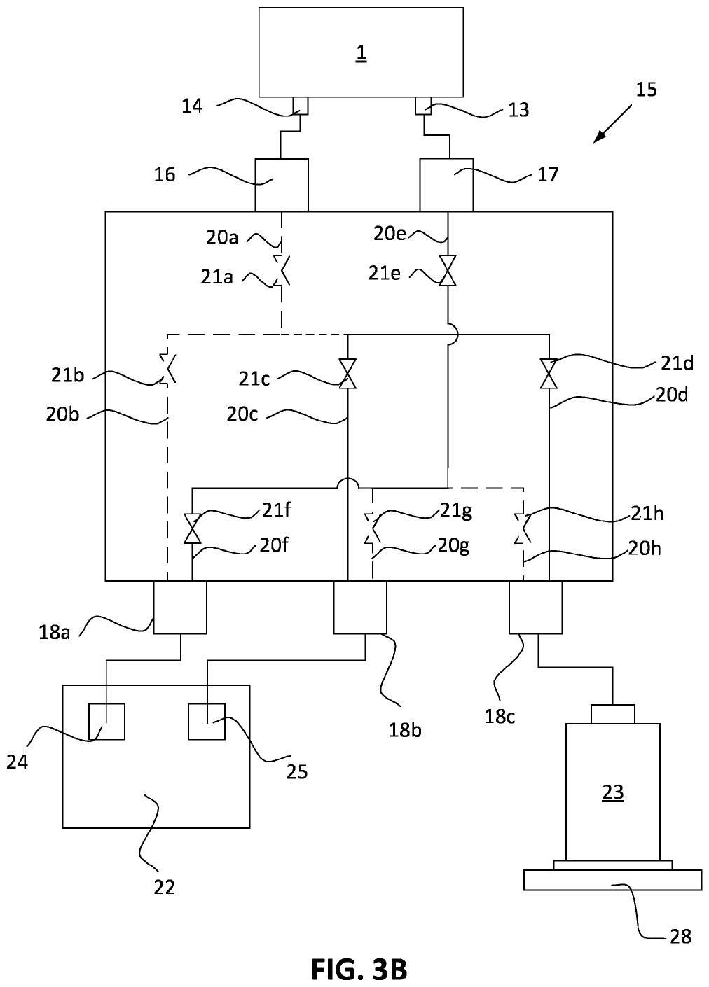

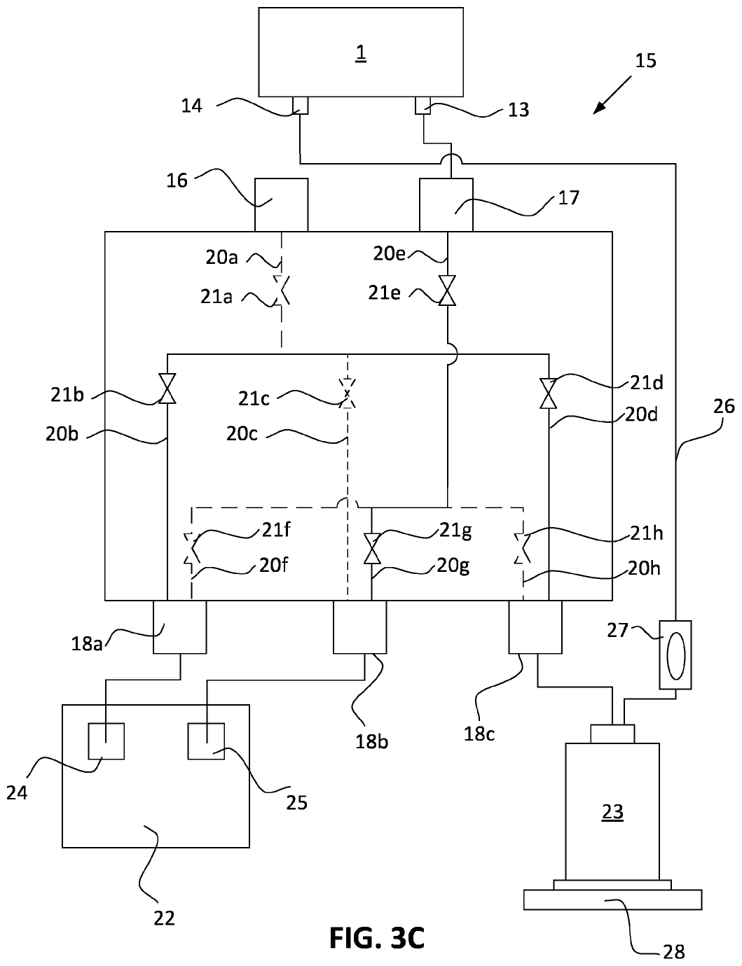

FIGS. 3A to 5, described below, show the hub of FIG. 2 as configured during various maintenance and commissioning procedures.

FIGS. 3A to 3C illustrate the hub of FIG. 2 during a refrigerant recovery procedure using a recovery unit 22 and a refrigerant tank 23. In FIGS. 3A to 3C, open fluid connections are shown in solid line, and closed fluid connections are shown in dotted line.

In a first configuration, illustrated in FIG. 3A, the first port 16 of the hub 15 is connected to the high pressure service port 14 of the HVAC-R system 1, and the second port 17 of the hub 15 is connected to the low pressure service port 13 of the HVAC-R system 1. An intake 24 of the recovery unit 22 is connected to the first maintenance port 18a, and the outlet 25 of the recovery unit 22 is connected to the second maintenance port 18b. The refrigerant tank 23 is connected to the third maintenance port 18c.

Within the hub 15, the electrically actuatable valves 21 are configured to provide a fluid connection from the first port 16 to the first maintenance port 18a and therefore between the high pressure service port 14 of the HVAC-R system 1 and the intake 24 of the recovery unit 22. Also, the electrically actuatable valves 21 are configured to provide a fluid connection between the second maintenance port 18b and the third maintenance port 18c to provide a fluid connection from the outlet 25 of the recovery unit 22 and the refrigerant tank 23.

To provide this configuration, electrically actuatable valves 21a, 21b, 21g, and 21h are open, and valves 21e, 21c, and 21d are closed.

In this configuration, the recovery unit 22 can be used to extract liquid refrigerant from the HVAC-R system 1 through the high pressure service port 14 of the HVAC-R system 1, and pump it into the refrigerant tank 23.

In an alternative configuration for refrigerant recovery, illustrated in FIG. 3B, the refrigerant is recovered in gas phase from the low pressure service port 13 of the HVAC-R system 1. In this example, the electrically actuatable valves 21 are configured to provide a fluid connection between the second port 17 and the first maintenance port 18a, instead of between the first port 16 and the first maintenance port 18a. In this configuration, electrically actuatable valves 21e, 21f, 21c and 21d are open, and valves 21a, 21b, 21g and 21h are closed. In this way, a fluid connection is provided between the low pressure service port 13 of the HVAC-R system 1 and the intake 24 of the recovery unit 22, and a further fluid connecting is provided between the outlet 25 of the recovery unit 22 and the refrigerant tank 23.

As illustrated in FIG. 3C, in a further alternative refrigerant recovery procedure termed ‘push-and-pull’ recovery, the high pressure service port 14 of the HVAC-R system 1 is connected directly to the refrigerant tank 23, preferably via a refrigerant hose 26 that includes a sight glass 27. The second port 17 of the hub is connected to the low pressure service port 13 of the HVAC-R system. The refrigerant tank 23 is also connected to the third maintenance port 18c, the intake 24 of the recovery unit 22 is connected to the first maintenance port 18a and the outlet of the recovery unit 22 is connected to the second maintenance port 18b.

Within the hub 15, the electrically actuatable valves 21 are configured to provide a fluid connection between the second port 17 and the second maintenance port 18b, thereby providing a fluid connection between the low pressure service port 13 of the HVAC-R system 1 and the outlet 25 of the recovery unit 22. The electrically actuatable valves 21 are also configured to provide a fluid connection between the first maintenance port 18a and the third maintenance port 18c, thereby providing a fluid connection between the intake of the recovery unit 22 and the refrigerant tank 23.

During the push-and-pull procedure, the recovery unit 22 draws refrigerant gas from the refrigerant tank 23, compresses it, and pumps the compressed refrigerant gas into the low pressure service port 13 of the HVAC-R system 1 via the hub 15. This pushes liquid refrigerant out of the HVAC-R system 1 via the high pressure service port 14 and into the refrigerant tank 23 via the hose 26 and sight glass 27. The technician watches the sight glass 27 for signs of gas, rather than liquid, which indicates that all of the liquid refrigerant has been recovered into the refrigerant tank 23. Once the liquid refrigerant has been removed, the gas recovery procedure described with reference to FIG. 3B can be performed to recover gas refrigerant from the HVAC-R system 1. This changeover requires only a change in the configuration of the fluid connections within the hub 15.

It is noted that because of the arrangement of pipes 20 and electrically actuatable valves 21 within the hub 15, each piece of maintenance apparatus could be connected to any of the maintenance ports 18a, 18b, 18c, and the HVAC-R system 1 can be connected to the first and second ports 16, 17 in either configuration.

As shown in FIGS. 3A to 3C, the refrigerant tank 23 is positioned on a set of scales 28. The scales 28 measure the weight of the refrigerant tank 23 and the refrigerant contained in the refrigerant tank 23, and can therefore be used to measure the weight of refrigerant recovered from the HVAC-R system 1.

The scales 28 may be in communication with the control unit of the hub 15, so that the control unit receives the detected weight of the refrigerant tank 23. The control unit may be configured to monitor the detected weight of the refrigerant tank 23 to determine when all of the refrigerant has been recovered (e.g. the weight of the refrigerant tank 23 stops rising).

The control unit may be configured to communicate the detected weight of the refrigerant tank 23 to a remote device, for example a tablet computer or mobile phone. Optionally, the control unit may be configured to control operation of the recovery unit 22 to turn off the recovery unit 22, or change an operating characteristic of the recovery unit 22, once the weight of the refrigerant tank 23 stops rising, indicating that all of the refrigerant has been recovered. At this stage, the control unit may additionally close the fluid connections to the HVAC-R system 1, for example by closing electrically actuatable valves 21a and 21e.

In some examples, more than one refrigerant tank 23 is required to receive the refrigerant from the HVAC-R system 1, and in this case the control unit of the hub 15 can be configured to pause operation of the hub and close one or more electrically actuatable valves while the full refrigerant tank 23 is replaced with an empty refrigerant tank 23.

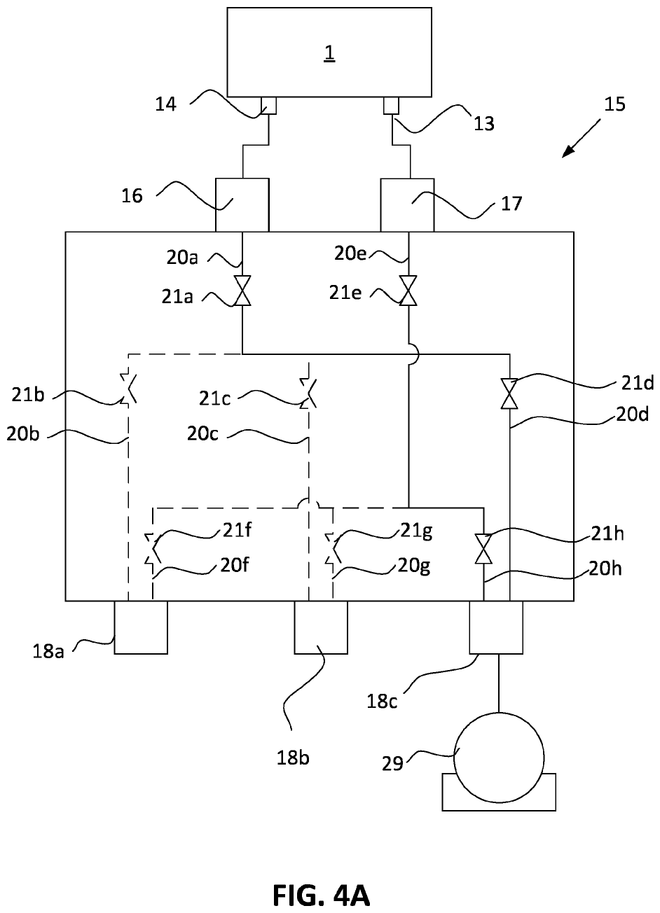

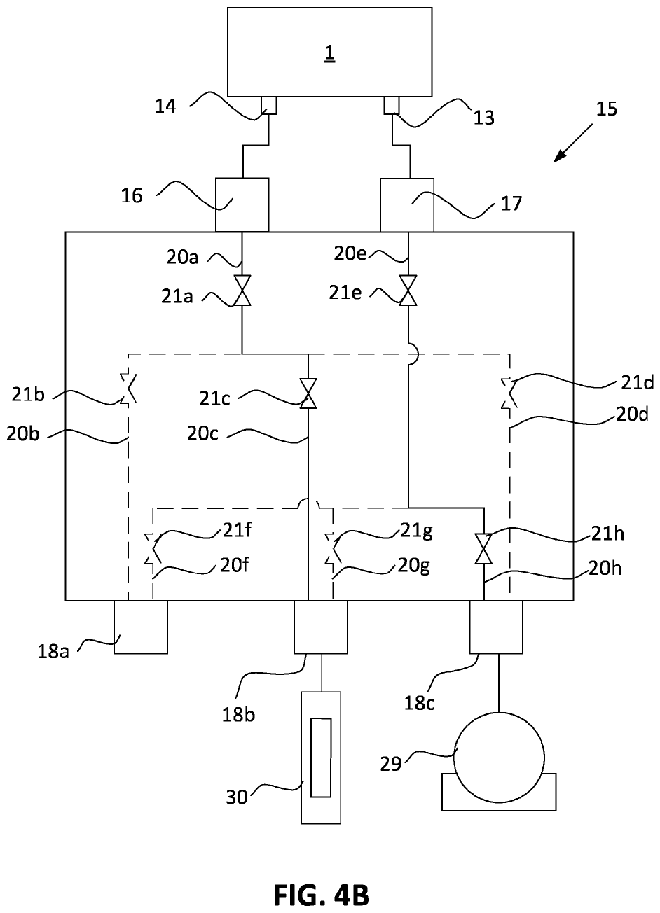

FIGS. 4A and 4B illustrate the hub of FIG. 2 during a vacuum extraction and test procedure using a vacuum pump 29. In FIGS. 4A and 4B open fluid connections are shown in solid line, and closed fluid connections are shown in dotted line.

As illustrated, for this procedure the first port 16 of the hub 15 is connected to the high pressure service port 14 of the HVAC-R system 1, the second port 17 of the hub 15 is connected to the low pressure service port 13 of the HVAC-R system 1, and the vacuum pump 29 is attached to the third maintenance port 18c. Within the hub 15, the electrically actuatable valves 21 are configured to provide a fluid connection between the first port 16 and the third maintenance port 18c, and between the second port 17 and the third maintenance port 18c. In this way, the vacuum pump 29 is fluidly connected to both of the high pressure and low pressure service ports 14, 13 of the HVAC-R system 1.

To provide this configuration, electrically actuatable valves 21a, 21d, 21e, and 21h are open, and electrically actuatable valves 21b, 21c, 21f, and 21g are closed.

In this configuration, the vacuum pump 29 draws a vacuum on the HVAC-R system 1 via both the high pressure service port 14 and the low pressure service port 13 in order to remove residual fluid in the HVAC-R system, including, for example, air that has entered the system during maintenance or installation. It will be appreciated that in other configurations, the vacuum pump 29 may draw a vacuum on the HVAC-R system 1 via only the high pressure service port 14 or via only the low pressure service port 13. The electrically actuatable valves 21 can be configured to provide the relevant connections.

In the example shown in FIG. 4B, a vacuum gauge 30 is connected to the second maintenance port 18b of the hub 15, and the electrically actuatable valves 21 are configured to provide a fluid connection between the second maintenance port 18b and the first port 16, and between the third maintenance port 18c and the second port 17. In this way, the vacuum pump 29 draws a vacuum on the HVAC-R system via the low pressure service port 13, and the vacuum gauge 30 is arranged to detect the vacuum level in the HVAC-R system via the high pressure service port 14. In this way, advantageously, the vacuum gauge 30 is connected at the point of the system furthest from the vacuum pump 29.

To provide the configuration shown in FIG. 4B, electrically actuatable valves 21a, 21c, 21e, 21h are open, and electrically actuatable valves 21b, 21f, 21d, 21g are closed.

The vacuum gauge 30 may be in communication with the control unit of the hub 15, so that the control unit receives the detected vacuum level. The control unit may be configured to monitor the detected vacuum level for a period of time to determine the seal integrity of the HVAC-R system 1. For example, the control unit may compare the detected vacuum level to a predetermined threshold vacuum level, and determine a time that the detected vacuum level has been more than or less than the threshold vacuum level to determine if the seal integrity meets a predetermined test.

The control unit may be configured to communicate the detected vacuum level and/or the time, or a result of the vacuum test, to a remote device, for example a tablet computer or mobile phone. Optionally, the control unit may be configured to control operation of the vacuum pump 29 to turn off the vacuum pump 29 once the test is complete. At this stage, the control unit may additionally close the fluid connections to the HVAC-R system 1 to maintain a vacuum within the HVAC-R system 1, for example by closing electrically actuatable valves 21a and 21e.

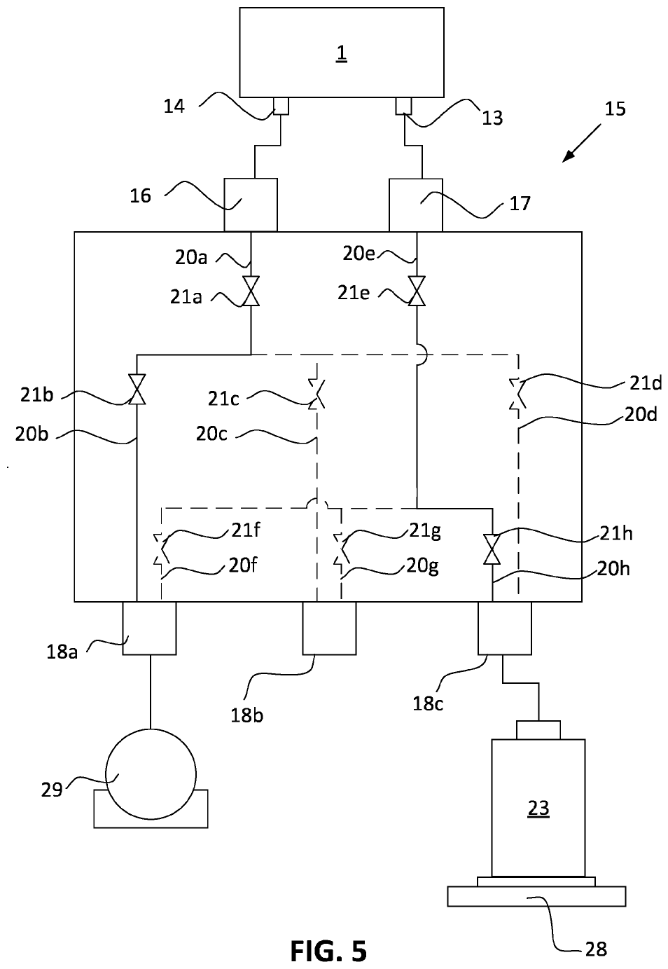

FIG. 5 illustrates the hub of FIG. 2 during a refrigerant charging procedure in which refrigerant to fed into the HVAC-R system 1. In FIG. 5, open fluid connections are shown in solid line, and closed fluid connections are shown in dotted line.

As illustrated, for this procedure the first port 16 of the hub 15 is connected to the high pressure service port 14 of the HVAC-R system 1, the second port 17 of the hub 15 is connected to the low pressure service port 13 of the HVAC-R system 1, the vacuum pump 29 is attached to the first maintenance port 18a, and the refrigerant tank 23 is connected to the third maintenance port 18c. Within the hub 15, the electrically actuatable valves 21 are configured to provide a fluid connection between the first port 16 and the first maintenance port 18a to provide a fluid connection between the vacuum pump and the high pressure service port 14. The electrically actuatable valves 21 are also configured to provide a fluid connection between the second port 17 and the third maintenance port 18c to provide a fluid connection between the low pressure service port 13 and the refrigerant tank 23.

To provide this configuration, electrically actuatable valves 21a, 21b, 21e, and 21h are open, and electrically actuatable valves 21c, 21d, 21f, and 21g are closed.

In this configuration, the vacuum pump 29 can be used to draw a vacuum on the high pressure service port 14 of the HVAC-R system 1. The vacuum can then be used to pull refrigerant from the refrigerant tank 23 into the HVAC-R system 1 from the low pressure service port 13. In some examples, this arrangement may be reversed, where the vacuum pump 29 is connected to the low pressure service port 13, and the refrigerant tank 23 is connected to the high pressure service port 14 by configuring the electrically actuatable valves 21 in the hub 15 accordingly.

In other examples, the vacuum pump 29 is not used. In this example, the refrigerant tank 23 is connected to the low pressure service port 13 via the hub 15, and gas phase refrigerant is thereby fed into the low pressure service port 13. The compressor (2, see FIG. 1) of the HVAC-R system 1 can be used to drive the refrigerant around the HVAC-R system 1 and thereby draw the refrigerant into the HVAC-R system 1 from the refrigerant tank 23.

During charging, as shown in FIG. 5, the refrigerant tank 23 is positioned on scales 28 to measure the weight of refrigerant that has been added to the HVAC-R system 1. In some examples, the scales 28 are digital scales and have a communications unit for communicating with a remote device and/or to the control unit of the hub. In these examples, the HVAC-R system 1 can be charged by instructing the remote device and/or the control unit of the hub 15 how much refrigerant to charge the HVAC-R system 1 with, in weight. Most HVAC-R systems have a set weight of refrigerant that they are designed to operate with. The control unit of the hub 15 and/or remote device can then operate the electrically actuatable valves 21 and/or the compressor (2, see FIG. 1) of the HVAC-R system 1 to provide the instructed weight of refrigerant to the HVAC-R system 1 by turning off the compressor (2, see FIG. 1), and/or by closing the electrically actuatable valves 21 once the correct weight of refrigerant has left the refrigerant tank 23.

In some examples, more than one refrigerant tank 23 is required to fill an HVAC-R system 1, and in this case the control unit of the hub 15 can be configured to pause charging and close one or more electrically actuatable valves while the empty refrigerant tank 23 is replaced with a full refrigerant tank 23.

In preferred examples, the hub further comprises an auto-purge capability for purging the hub of refrigerant after use of the hub in any of the above-described operations. The auto-purge capability may comprise closing one or more of the electrically actuatable valves and utilising a recovery unit to ensure that all of the refrigerant has left the hub, either into the HVAC-R system 1 or into the refrigerant tank 23.

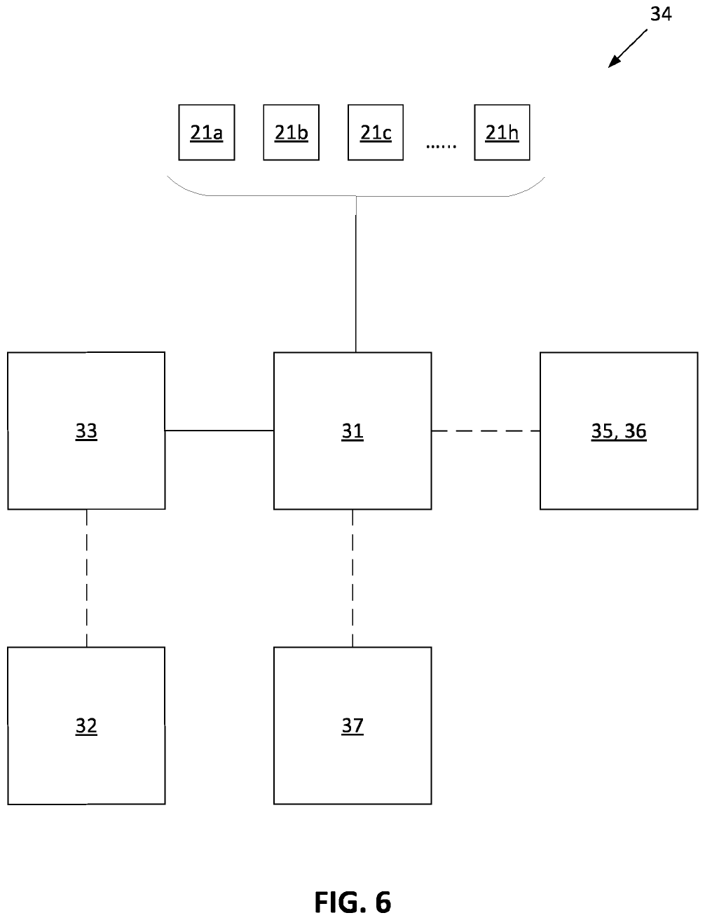

FIG. 6 illustrates a control system 34 for the apparatus described above, particularly the hub 15. The control unit 31 of the hub 15 provides control signals and/or power to each of the electrically actuatable valves 21a . . . 21h. The control unit 31 also communicates with a remote device 32 via the communications unit 33.

Optionally, the control unit 31 may communicate with a remote detector 36, such as the scales 28 described with reference to FIGS. 3A-3C and FIG. 5, or the vacuum gauge 30 described with reference to FIG. 4B. Additionally or alternatively, the control unit 31 may communicate with an integrated detector 35 that is integrated into the hub 15, such as the pressure sensors described with reference to FIG. 2.

The control unit 31 preferably comprises a processor for processing data, such as instructions and data received from one or more of the remote device 32, the remote detector, and/or the integrated sensor 36. The control unit 31 preferably comprises a memory for storing data, for example data for pre-set instructions on different configurations of the electrically actuatable valves 21. For example, the memory may store data for configurations of the electrically actuatable valves 21 for the procedures described with reference to FIGS. 3A to 5. The control unit 31 may be configured to retrieve data from the memory.

The control system 34 may optionally further comprise an input device 37. For example, the control system 34 may comprise one or more buttons or switches, or a graphical user interface, such as a touchscreen, for a user to provide information and/or commands to the control unit 31. In one example, a user provides an instruction to the control unit 31 via the input device 37, for example a ‘refrigerant recovery—gas’ instruction. In response, the control unit 31 retrieves from the memory data for the relevant pre-set configuration of the electrically actuatable valves 21, which is shown in FIG. 3A, and the control unit 31 configures the electrically actuatable valves 21 in this way to provide the relevant fluid connections.

The input device 37 may be further configured to allow a user to input information about what connections are provided to the first port 16, the second port 17 and the maintenance ports 18a, 18b, 18c, in particular if these ports 16, 17, 18a, 18b, 18c are connected to the HVAC-R system and/or maintenance equipment. For example, the user may input that the first port 16 is connected to the high pressure service port 14 of the HVAC-R system, the second port 17 is connected to the low pressure service port 13 of the HVAC-R system, and a vacuum pump 29 is connected to the third maintenance port 18c, as shown in FIG. 4A.

In some examples, each of the first port 16, second port 17 and maintenance ports 18a, 18b, 18c may comprise a sensor to detect a connection. For example, each port 16, 17, 18a, 18b, 18c may comprise a proximity sensor to detect whether or not a hose is connected to the port 16, 17, 18a, 18b, 18c. These sensors may be in communication with the control unit 31, the control unit 31 is preferably configured only to open electrically actuatable valves 21 associated with a port 16, 17, 18a, 18b, 18c if such a connection is detected by the sensor.

In some examples, the hub 15 may be integrated with other maintenance equipment. For example, the hub 15 may be integrated into the recovery unit described with reference to FIGS. 3A to 3C. In this example, the combined hub 15 and recovery unit 22 comprises ports 16, 17 for connection to the HVAC-R system 1, ports 18a, 18b, 18c for connection to further maintenance equipment, for example a refrigerant tank 23, and a pump that performs the function of the recovery unit 22. Fluid connections are provided between the ports 16, 17, 18a, 18b, 18c and an intake and outlet of the pump, and electrically actuatable valves 21 can be configured to provide fluid connections as relevant.

Similarly, the hub 15 may be integrated to a vacuum pump, such as the vacuum pump 29 described with reference to FIGS. 4A to 5.

In summary, there is provided apparatus for connection to an HVAC-R system during maintenance or commissioning. The apparatus comprises a plurality of ports for fluid connection to the HVAC-R system and to maintenance apparatus, for example a refrigerant tank, a refrigerant recovery unit and/or a vacuum pump. The apparatus also includes a plurality of fluid connections between the plurality of ports, and each of the fluid connections has an electrically actuatable valve to open and close the fluid connection. The apparatus also has a control unit that is configured to control each of the electrically actuatable valves to configure the plurality of fluid connections. There are also provided method of performing maintenance and/or commissioning on an HVAC-R system using the apparatus.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. Apparatus for connection to an HVAC-R system during maintenance or commissioning, the apparatus comprising:
a plurality of ports for fluid connection to the HVAC-R system and to maintenance apparatus, for example a refrigerant tank, a refrigerant recovery unit and/or a vacuum pump,
a plurality of fluid connections between the plurality of ports, each of the plurality of fluid connections having an electrically actuatable valve to open and close the fluid connection,
a control unit configured to control each of the electrically actuatable valves to configure the plurality of fluid connections.

2. The apparatus of claim 1, wherein the control unit further comprises a communications unit configured to communicate with a remote device.

3. The apparatus of claim 2, wherein the communications unit comprises a Bluetooth communications unit.

4. The apparatus of any preceding claim, wherein the plurality of ports comprises a first port for connection to a high pressure service port of the HVAC-R system and a second port for connection to a low pressure service port of the HVAC-R system.

5. The apparatus of claim 4, wherein the plurality of ports further comprises a maintenance port for connection to the maintenance apparatus.

6. The apparatus of claim 5, wherein the plurality of ports comprises a first maintenance port and a second maintenance port, and wherein the plurality of ports optionally further comprises a third maintenance port.

7. The apparatus of claim 6, wherein the apparatus comprises a fluid connection between the first maintenance port and the second maintenance port, and wherein the fluid connection comprises an electrically actuatable valve to open and close the fluid connection.

8. The apparatus of any of claims 5 to 7, wherein the or each maintenance port is connectable to both of the first port and the second port via fluid connections, each of the fluid connections comprising an electrically actuatable valve to open and close the fluid connection.

9. The apparatus of any preceding claim, further comprising a pressure sensor arranged to detect a pressure of fluid in at least one fluid connection.

10. The apparatus of any preceding claim, further comprising a temperature sensor arranged to detect a temperature of fluid in at least one fluid connection.

11. The apparatus of any preceding claim, wherein at least one of, and preferably all of, the electrically actuatable valves are biased to a closed position.

12. The apparatus of any preceding claim, wherein the control unit is configured to receive an input for configuring the electrically actuatable valves.

13. The apparatus of claim 12, wherein the control unit comprises a memory configured to store pre-set configurations of the electrically actuatable valves, and wherein the control unit is configured to retrieve a pre-set configuration from the memory.

14. The apparatus of claim 12 or claim 13, wherein the control unit comprises an input device, and wherein the control unit is configured to configure the electrically actuatable valves in accordance with a user instruction provided to the control unit via the input device.

15. The apparatus of any preceding claim, further comprising a pump for pumping refrigerant fluid.

16. The apparatus of any preceding claim, further comprising a vacuum pump.

17. The apparatus of any preceding claim, wherein the apparatus comprises a housing to which the ports, fluid connections and electrically actuatable valves are attached, and wherein the housing is portable.

18. A method of performing maintenance or commissioning on an HVAC-R system, the method comprising:
providing the apparatus of any preceding claim,
connecting a first port of the apparatus to the HVAC-R system;
connecting a second port of the apparatus to maintenance apparatus; and
configuring the electrically actuatable valves to provide a fluid connection between the first port and the second port.

19. A method of performing maintenance or commissioning on an HVAC-R system, the method comprising:
providing the apparatus of any of claims 1 to 17, the apparatus comprising:
a first port for connection to a high pressure service port of the HVAC-R system;
a second port for connection to a low pressure service port of the HVAC-R system; and
at least one maintenance port for connection to the maintenance apparatus; and wherein the method further comprises:
connecting at least one of the first port and the second port of the apparatus to the HVAC-R system,
connecting the maintenance port of the apparatus to maintenance or commissioning apparatus, and
configuring the electrically actuatable valves to provide a fluid connection between the first port and/or the second port and the maintenance port.

20. The method of claim 19, wherein the method comprises:
connecting the first port of the apparatus to a high pressure service port of the HVAC-R system;
connecting first and second maintenance ports of the apparatus to an intake and an outlet of a recovery unit, respectively;
connecting a third maintenance port to a refrigerant tank; and
configuring the electrically actuatable valves to provide fluid connections between the first port and the first maintenance port, and between the second maintenance port and the third maintenance port.

21. The method of claim 19, wherein the method comprises:
connecting the second port of the apparatus to a low pressure service port of the HVAC-R system;
connecting first and second maintenance ports of the apparatus to an intake and an outlet of a recovery unit, respectively;
connecting a third maintenance port to a refrigerant tank; and
configuring the electrically actuatable valves to provide fluid connections between the second port and the first maintenance port, and between the second maintenance port and the third maintenance port.

22. The method of claim 19, wherein the method comprises:
connecting the first port of the apparatus to a high pressure service port of the HVAC-R system;
connecting a first maintenance port of the apparatus to an intake of a vacuum pump; and,
configuring the electrically actuatable valves to provide a fluid connection between the first port and the first maintenance port.

23. The method of claim 19 or claim 21, wherein the method comprises:
connecting the second port of the apparatus to a low pressure service port of the HVAC-R system;
connecting a first maintenance port of the apparatus to an intake of a vacuum pump; and,
configuring the electrically actuatable valves to provide a fluid connection between the second port and the first maintenance port.

24. The method of any of claim 19, 22 or 23, wherein the method comprises:
connecting the first port of the apparatus to a high pressure service port of the HVAC-R system, and/or connecting the second port of the apparatus to a low pressure service port of the HVAC-R system;
connecting a third maintenance port to a refrigerant tank; and
configuring the electrically actuatable valves to provide a fluid connection between the third maintenance port and at least one of the first port and the second port.
